(19) United States
(12) Patent Application Publication
(10) Pub. No.: US 2019/0118751 A1
(43) Pub. Date: Apr. 25, 2019

(54) CLASSIFYING NON-CONTACT EVENTS AROUND A VEHICLE BASED ON A RESTRAINT CONTROL MODULE ACCELEROMETER

(71) Applicant: Ford Global Technologies, LLC, Dearborn, MI (US)

(72) Inventors: Mahmoud Yousef Ghannam, Canton, MI (US); Howard E. Churchwell, II, Monroe, MI (US); Brian Bennie, Sterling Heights, MI (US); David James Tippy, Ann Arbor, MI (US)

(21) Appl. No.: 15/788,727

(22) Filed: Oct. 19, 2017

(51) Int. Cl. B60R 21/0132

(52) U.S. Cl. CPC B60R 21/01336; B60R 2021/01013

(57) ABSTRACT

Method and apparatus are disclosed for classifying non-contact event around a vehicle based on a restraint control module accelerometer. An example vehicle includes impact sensors, a metal panel on an underside of the vehicle, an accelerometer mounted to the metal panel to measure vibrations of the metal panel caused by sound, a restraint control module. The restraint control module (a) classifies the sound as a collision event or a non-collision event, and (b) deploys an airbag when the sound is classified as the collision event and the impact sensors indicate the collision event.

### TECHNICAL FIELD

The present disclosure generally relates to detecting collisions in a vehicle and, more specifically, classifying non-contact event around a vehicle based on a restraint control module accelerometer.

### BACKGROUND

Typically, a vehicle includes seatbelts to restrain a position of an occupant within the vehicle. A vehicle also typically includes airbags (e.g., a driver airbag, a passenger airbag, a side-impact airbag, a side-curtain airbag, etc.) that deploy to further restrain an occupant when the vehicle is involved in a collision. The airbags are to be fully inflated within a short period of time of the collision being detected to enable the airbags to restrain the occupant throughout the duration of the collision. Oftentimes, a vehicle includes a restraint control module that detects whether the vehicle is involved in a collision, determines whether to deploy airbag(s) of the vehicle, and sends signal(s) to activate the airbag(s) upon determining to deploy the airbag(s).

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Method and apparatus are disclosed for classifying non-contact event around a vehicle based on a restraint control module accelerometer. An example vehicle includes impact sensors, a metal panel on an underside of the vehicle, an accelerometer mounted to the metal panel to measure vibrations of the metal panel caused by sound, a restraint control module. The restraint control module (a) classifies the sound as a collision event or a non-collision event, and (b) deploys an airbag when the sound is classified as the collision event and the impact sensors indicate the collision event.

A method includes measuring vibrations caused by sound of a metal panel on an underside of a vehicle with an accelerometer mounted on the metal panel. The method also includes measuring vibrations of a frame of the vehicle with impact sensors. Additionally the method includes classifying the vibrations of the metal panel as a collision event or a non-collision event and classifying the vibration of the frame as the collision event or the non-collision event. Further, the method includes deploying an airbag when the sound is classified as the collision event and the vibration of the frame is classified as the collision event.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a vehicle operating in accordance with the teachings of this disclosure.

FIG. 2A depicts a graph representing a collision event as detected by the vehicle of FIG. 1.

FIG. 2B depicts a graph representing a non-collision event as detected by the vehicle of FIG. 1.

FIG. 3 illustrates a non-collision event occurring next to the vehicle of FIG. 1.

FIG. 4. is a block diagram of electronic components of the vehicle of FIG. 1.

FIG. 5 is a flowchart of a method to distinguish collision and non-collision events, which may be implemented by the electronic components of FIG. 4.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Typically, a vehicle includes seatbelts to restrain a position of an occupant within the vehicle. A vehicle also typically includes airbags (e.g., a driver airbag, a passenger airbag, a side-impact airbag, a side-curtain airbag, etc.) that deploy to further restrain an occupant when the vehicle is involved in a collision. The airbags are to be fully inflated within a short period of time of the collision being detected to enable the airbags to restrain the occupant throughout the duration of the collision. Oftentimes, a vehicle includes a restraint control module that detects whether the vehicle is involved in a collision, determines whether to deploy airbag(s) of the vehicle, and sends signal(s) to activate the airbag(s) upon determining to deploy the airbag(s).

Some vehicles include forward and side collision sensors (e.g., pressure sensors, accelerometers) that are located throughout a body of the vehicle to detect whether the vehicle has been involved in a collision. In such vehicles, the sensors detect vibrations of the body of the vehicle to determine whether the vehicle is involved in a collision. That is, a collision is detected if the detected vibrations of the vehicle body exceed a particular threshold. In some instances, nearby non-collisions events, such as puncturing tires of nearby semi-trucks, emit a sound that is loud enough to vibrate the vehicle body above the particular threshold, thereby potentially causing airbags of the vehicle to deploy when the vehicle is not involved in a collision.

As described below, the restraint control module (RCM) includes an accelerometer to distinguish between collision events and non-collision events based on sounds waves detected by the accelerometer. As used herein, a “collision event” refers to an event in which the vehicle collides with and/or is collided with another vehicle and/or object. As used herein, a “non-collision event” refers to an event in which the vehicle does not collide with and is not collided with another vehicle and/or object. The accelerometer is mounted to a metal sheet located on the undercarriage of the vehicle. Sometimes, the metal sheet is formed as a tunnel. Because the metal sheet is thin, it acts as a diaphragm that vibrates under the effect of external sound waves. The vibrations are measured by the accelerometer of the RCM. The signal captured by the accelerometer is filtered, processed, and examined in the time and frequency domains. The processed signals are compared to a database of event signatures to categorize the signal as either a collision event or a non-collision event. When (a) the processed signal matched one of the signatures in the database of event signatures associated with a collision event and (b) the forward or side collision sensors detect a collision, the RCM classifies in the in collision as a front impact or a side impact (and, in some examples, classifies the collision based on which side) and activates one or more air bag(s) of the vehicle. If the processed signal corresponds to one of the signatures in the database of event signatures associated with a non-collision event (e.g., a nearby event that emits high-pressure sound waves), the restraint control module does not activate an airbag. Further, in some examples, the accelerometer of the RCM may be utilized to detect sources of other sounds (e.g., animals, people, etc.) emitted near the vehicle.

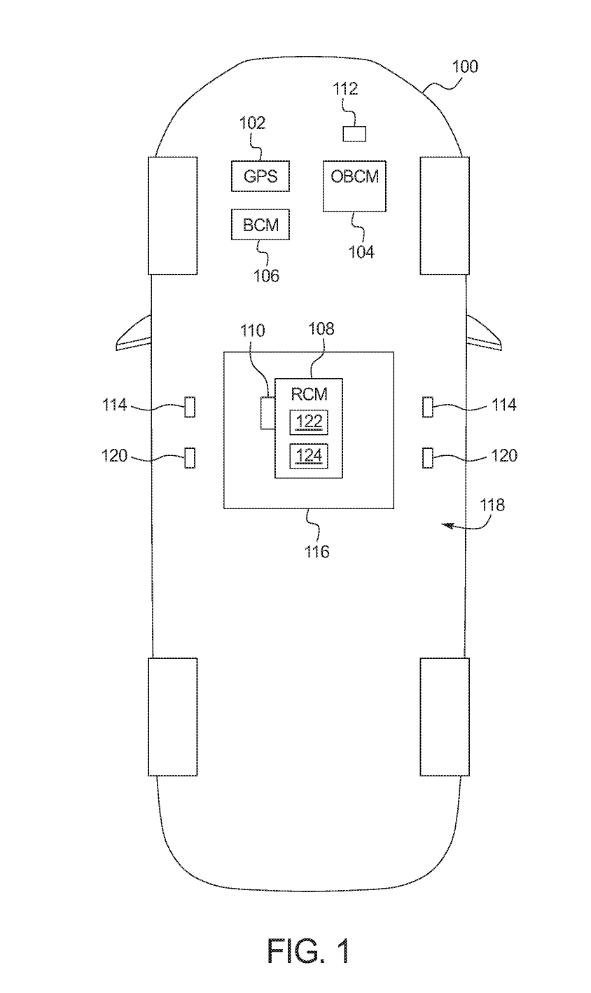

FIG. 1 illustrates an underside of a vehicle 100 operating in accordance with the teachings of this disclosure. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). In the illustrated example the vehicle 100 includes a global positioning system (GPS) receiver 102, an on-board communication module (OBCM) 104, a body control module (BCM) 106, and a restraint control module (RCM) 18. The GPS receiver 102 receives a signal from a global positioning system to identify a location of the vehicle 100. Further, the on-board communication module 104 is configured to communicate with external networks and/or communicate, via dedicated short-range communication (DSRC), with other vehicles, infrastructure nodes (e.g., DSRC-enabled devices such as traffic signals, etc.), and/or pedestrians (e.g., via DSRC-enable mobile devices, etc.).

The on-board communication module 104 of the illustrated example includes wired or wireless network interfaces to enable communication with external networks. The on-board communication module 104 also includes hardware (e.g., processors, memory, storage, antenna, etc.) and software to control the wired or wireless network interfaces. In the illustrated example, the on-board communication module 104 includes one or more communication controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); Near Field Communication (NFC), local area wireless network (including IEEE 802.11 a/b/g/n/ac or others), Wireless Gigabit (IEEE 802.11ad), etc.). In some examples, the on-board communication module 104 includes a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle 100 may communicated with the external network via the coupled mobile device. The external network(s) may be a public network, such as the Internet; a private network, such as an intranet; or combinations thereof, and may utilize a variety of networking protocols now available or later developed including, but not limited to, TCP/IP-based networking protocols.

In some examples, the on-board communication module 104 also includes a DSRC controller configured to communicate via vehicle-to-vehicle (V2V) communication and vehicle-to-infrastructure (V2I) using DSRC or any other communication protocol. The DSRC controller includes antenna(s), radio(s) and software to broadcast messages and to establish connections between the vehicle 100 and another vehicle (V2V communication), infrastructure-based modules (V2I communication), and mobile device-based modules. More information on the DSRC network and how the network may communicate with vehicle hardware and software is available in the U.S. Department of Transportation's Core June 2011 System Requirements Specification (SyRS) report (available at http://www.its.dot.gov/meetings/pdf/CoreSystem_SE_SyRS_RevA%20(2011-06-13).pdf), which is hereby incorporated by reference in its entirety along with all of the documents referenced on pages 11 to 14 of the SyRS report. DSRC systems may be installed on vehicles and along roadsides on infrastructure.

The body control module 106 controls various subsystems of the vehicle 100. For example, the body control module 106 may control power windows, power locks, an immobilizer system, and/or power mirrors, etc. The body control module 106 includes circuits to, for example, drive relays (e.g., to control wiper fluid, etc.), drive brushed direct current (DC) motors (e.g., to control power seats, power locks, power windows, wipers, etc.), drive stepper motors, and/or drive LEDs, etc.

The restraint control module 108 of the illustrated example deploys one or more airbags within the vehicle 100 upon detecting that the vehicle 100 is involved in a collision event. Upon detecting a collision event, the restraint control module 108 deploys one or more airbags within the vehicle 100 to restrain the position(s) of the occupant(s) within the vehicle 100 during the collision event based on a categorization of the collision event (e.g., a front impact, a side impact, etc.). The vehicle 100 includes an airbag located within a steering wheel to restrain a position of a driver during a collision event and includes another airbag located in a dashboard to restrain a position of a front-seat passenger during a collision event. Additionally or alternatively, the vehicle 100 may include one or more other airbags such as side-impact airbag(s) and/or curtain airbag(s).

The restraint control module 108 determines which, if any, of the airbags to deploy upon identifying a collision type, an angle of impact, a severity of impact, and/or any other characteristic of the collision event. For example, the restraint control module 108 deploys one or more airbag(s) if the collision event exceeds a severity threshold and does not deploy an airbag if the collision event does not exceed the severity threshold. In some examples, the restraint control module 108 determines which, if any, of the airbags to deploy upon identifying which of the seats of the vehicle 100 are occupied. Further, upon detecting a collision event, the restraint control module 108 quickly causes one or more of the airbags to deploy to restrain the position(s) of the occupant(s) within the vehicle 100. In some examples, the restraint control module 108 determines which, if any, of the airbags are to be deployed within about 15 to 30 milliseconds upon the onset of the collision event, and the airbag(s) are to be fully inflated with about 60 to 80 milliseconds upon the onset of the collision event to restrain the position(s) of the occupant(s) within the vehicle 100. For example, the restraint control module 108 send signals to trigger pyrotechnic process(es) and/or compressed air cylinder(s) that enable the restraint control module 108 to quickly deploy the airbags of the vehicle 100.

In some examples, the restraint control module 108 also controls seat belt mechanism(s) to further restrain the position(s) of the occupant(s) during the collision event. For example, upon detecting a collision event, the restraint control module 108 may activate a seat belt pretensioner to remove slack from the seat belt and/or a webclamp to clamp webbing of the seatbelt to limit a length of the seatbelt that the webbing is able to spool out.

The restraint control module 108 of the illustrated example determines which, if any, of the airbags to deploy based upon information collected via one or more sensors (e.g., accelerometers, impact sensors, pressure sensors, wheel speed sensors, gyroscopes, brake pressure sensors, seat occupancy sensors, etc.) and/or other data source(s) (sometime referred to collectively as “impact sensors”). For example, the vehicle 100 includes a center accelerometer 110 (e.g., a first accelerometer), a front accelerometer 112, and side accelerometers 114. For example, the center accelerometer 110, the front accelerometer 112, and the side accelerometers 114 are sensors that measure accelerations (e.g., proper accelerations within an instantaneous rest frame of the vehicle 100) and/or vibrations of the vehicle 100.

The center accelerometer 110, the front accelerometer 112, and the side accelerometers 114 of the illustrated example measure the accelerations and/or vibrations of the vehicle 100 to monitor for an occurrence, location, and/or severity of a collision event of the vehicle 100. For example, the center accelerometer 110 is centrally located within the vehicle 100 that measures accelerations and/or vibrations of a body of the vehicle 100 to monitor for an occurrence, location, and/or severity of a collision event. In the illustrated example, the restraint control module 108 includes the center accelerometer 110 and is mounted to a metal sheet 116 (sometimes referred to as a “metal panel”) on an underside 118 of the vehicle 100 between a driver seat and a front-passenger seat. The front accelerometer 112 is located toward a front of the vehicle 100 that measures accelerations and/or vibrations of a front portion of the vehicle 100 to monitor for an occurrence, location, and/or severity of a collision event (e.g., a head-on collision, a rear-end collision). Additionally, the vehicle 100 includes a rear sensor located toward a rear of the vehicle 100 that measures accelerations and/or vibrations of a rear portion of the vehicle 100 to monitor for an occurrence, location, and/or severity of a head-on collision and/or a rear-end collision. Further, the side accelerometers 114 are located on respective sides of the vehicle 100 and measure accelerations and/or vibrations of respective side portions of the vehicle 100 to monitor for an occurrence, location, and/or severity of a collision event (e.g., a side collision). In the illustrated example, the side accelerometers 114 are located within respective doors of the vehicle 100 to monitor for side collisions that occur at and/or near the doors.

Additionally or alternatively, the restraint control module 108 of the illustrated example determines which, if any, of the airbags to deploy based upon information collected via side pressure sensors 120. For example, the side pressure sensors 120 measure changes in pressure and/or vibrations of the respective side portions of the vehicle 100 to monitor for an occurrence, location, and/or severity of a collision event (e.g., a side collision). In the illustrated example, the side pressure sensors 120 are located within the respective doors of the vehicle 100 to monitor for side collisions that occur at and/or near the doors.

Further, in some examples, the restraint control module 108 determines which, if any, of the airbags to deploy based upon information collected via other sources. In some such examples, the vehicle 100 includes cameras that capture image(s) and/or video of portions of an exterior of the vehicle. The image(s) and/or video captured by the cameras are utilized to determine whether the vehicle 100 is involved in a collision event. The cameras may be located on respective side-view mirrors to monitor respective side portions of the vehicle 100. Additionally or alternatively, the vehicle includes camera(s) location at other location(s) of the vehicle 100 to monitor other exterior portion(s) of the vehicle 100.

In the illustrated example, the restraint control module 108 includes a database of collision signatures 122 and a sound monitor 124. The sound monitor 124 processes signals produced by the center accelerometer 110 that are caused by sounds waves contacting the metal sheet 116 and, when the signal is indicative of a collision event, it enables the restraint control module 108 to deploy the air bag(s) as described above. That is, when the signal is not indicative of a collision event, the restraint control module 108 determines that the signals from the other sensors (e.g., the front accelerometer 112, the side accelerometers 114, the side pressure sensors 120, etc.) that are indicative of a collision event are actually false positives caused by vibrations of the vehicle 100 caused by a non-collision event and does not deploy the air bag(s). In such a manner, the sound monitor 124 prevents the restraint control module 108 from deploying the air bag(s) as a result of a non-collision event.

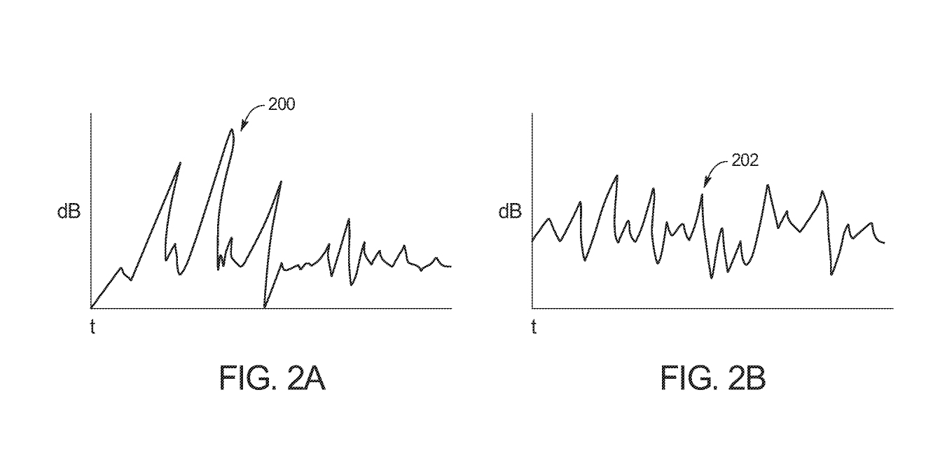

The database of collision signatures 122 contains signatures to be compared to the signals from the center accelerometer 110 that are processed by the sound monitor 124. As used herein, a signature is an identifiable segment of a signal in the time domain or the frequency domain that is associated with a source of sound. For example, a signature may associate a signal in the frequency domain to the sound of a tire blowout. The database of collision signatures 122 may be any suitable data structure that associates a time or frequency domain representation of a sound to an event, phenomenon, and/or source of the sound. FIG. 2A illustrates an example of a signature 200 indicative of a collision event (e.g., the sound of another vehicle colliding with the vehicle 100). FIG. 2B illustrates an example of a signature 202 indicative of a non-collision event (e.g., the sound of a tire blowout). In general, signatures indicative of collision events tend to have steeper rates of change of the signal, higher valley-to-peak ratios, and lower frequency components. From time-to-time, in some examples, the sound monitor 124 maintains the database of collision signatures 122. In some such examples, the sound monitor 124 connects to an external server (e.g., via the on-board communication module 104) to keep the signatures in the database of collision signatures 122 up-to-date.

The sound monitor 124 filters and processes, in the time and frequency domains, the signals caused by sound waves interacting with the metal sheet 116. The sound monitor 124 compares the processed signal to the signatures in the database of collision signatures 122 to determine whether the signal was caused by a sound from a collision event or a non-collision event. In some examples, the sound monitor 124 also considers other information when classifying the signal. In some such examples, the sound monitor 124 receives information from sensors (e.g., wiper rain sensor, exterior temperature sensor, etc.), the location of the vehicle 100 (e.g., from the GPS receiver 102), and/or weather information for the area (e.g., from an external weather server via the on-board communication module 104). For example, based on the weather in the area, the sound monitor 124 may prioritize comparing the processed signal to weather-related signatures (e.g., rain fall, vehicles driving in rain, thunder, etc.) In some examples, the sound monitor 124 receives information from other vehicles (e.g., via DSRC) indicating that the other vehicles detected a collision. In some examples, when the sound monitor 124 determines that the processed signal is of a non-collision event, the sound monitor 124, via a sound system, provides an alert to the occupants of the vehicle and/or replays the processes signal in the interior of the vehicle 100. For example, the sound monitor 124 may provide an alert when the process signal is categorized as an animal noise. As another example, the sound monitor 124 may plays the processed signal on the sound system when the processed signal is categorized as speech. In some examples, the sound monitor 124 plays the signal from the center accelerometer 110 on the sound system them the vehicle 100 is in a reverse gear. In some such examples, the sound monitor 124 processes and filters the signal and then plays it directly on the sound system. Alternatively, in some such examples, the sound monitor 124 only plays the signal on the sound system the corresponding signature in the database of collision signatures is flagged to do so. In such a manner, the sound monitor 124 may also assist a driver detect objects (e.g., animals, children, etc.) when the vehicle 100 is traveling in reverse. In some example, when the sound monitor 124 classifies the processed signal as a non-collision event, the sound monitor 124 broadcasts, via the on-board communication module 104, a message informing other vehicles in the area of the time and/or location of the non-collision event.

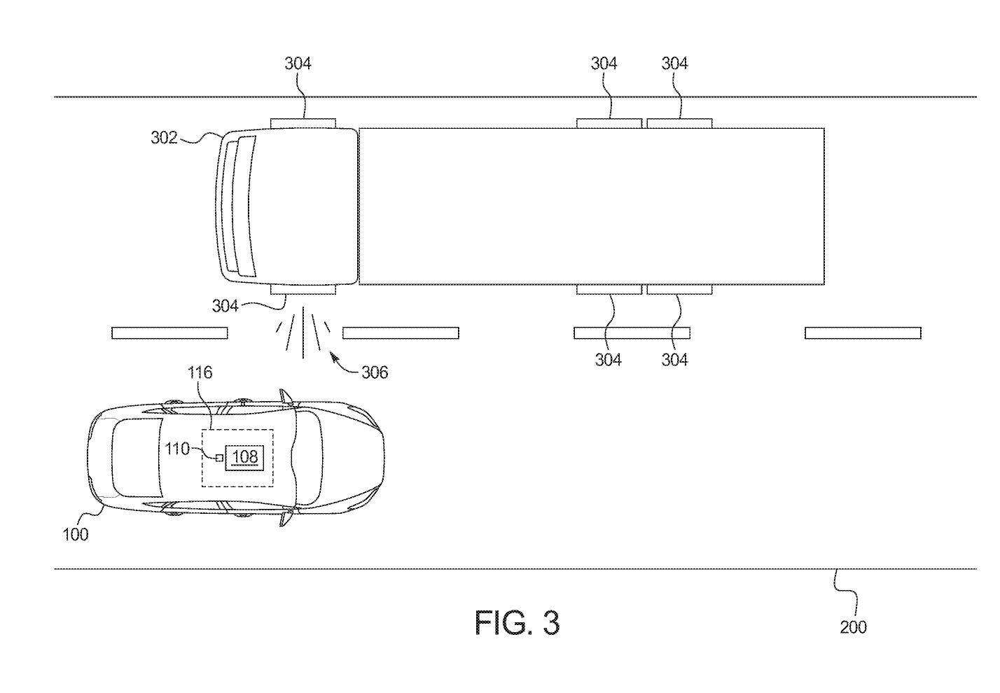

FIG. 3 illustrates a non-collision event occurring next to the vehicle 100 of FIG. 1. In the illustrated example, the non-collision event is a blowout of the tire of a nearby vehicle. For example, the vehicle 100 is travelling along a road 300 next to a semi-truck 302 that includes a plurality of tires 304. One of the tires 304 blows out, which emits sound waves 306 in a direction toward the vehicle 100.

In the illustrated example, the center accelerometer 110 coupled to the metal sheet 116 detects the vibrations caused by the sound waves 306 emitted by the blown out one of the tires 304. The sound monitor 124 of the restraint control module 108 determines whether the vehicle 100 is involved in a collision event or a non-collision event. For example, the sound waves 306 cause vibrations within the vehicle body of the vehicle 100 that are detected by one of the side accelerometers 114 adjacent to the semi-truck 302, and/or one of the side pressure sensors 120 adjacent to the semi-truck 302. In some instances the blow out of the one of the tires 304 is so loud that the vehicle body vibrations caused by the sound waves 306 exceed a vibration threshold that causes the restraint control module 108 to detect a possible collision event (even though it is not).

To prevent the airbags of the vehicle 100 from being deployed for the non-collision event, the sound monitor 124 of the restraint control module 108 also monitors the vibrations of the metal sheet 116 that are measured by the center accelerometer 110. Further, the sound monitor 124 compares the processed signal from the center accelerometer 110 caused by the vibrations of the metal sheet 116 to signatures in the database of collision signatures 122 to determine whether the detected event is a collision event or a non-collision event.

In the illustrated example, the sound monitor 124 determines that the detected event is a non-collision event based upon the comparison of the signal from the vibrations of the metal sheet 116 to the signatures in the database of collision signatures 122. Further, in some examples, the sound monitor 124 identifies another source of sound waves (e.g., a person, an animal, a car horn, etc.) based upon the comparison of the signal from the vibrations of the metal sheet 116 to the signatures in the database of collision signatures 122. For example, the sound monitor 124 may determine that the sound was that of a blown out tire and cause the sound system to say, “Blown out tire detected on a nearby vehicle.”

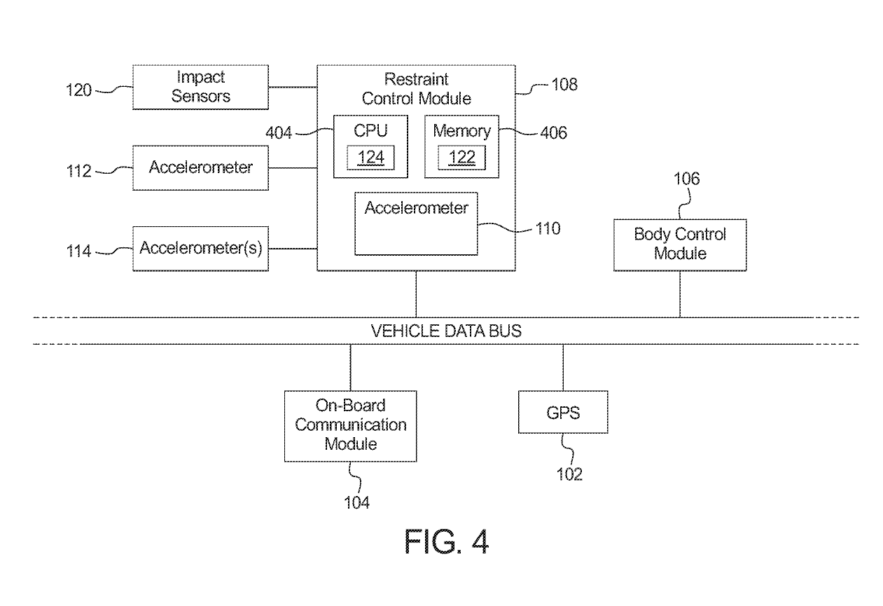

FIG. 4. is a block diagram of electronic components 400 of the vehicle of FIG. 1. In the illustrated example, the electronic components 400 include the GPS receiver 102, the on-board communication module 104, the body control module 106, the restraint control module 108, the center accelerometer 110, the front accelerometer 112, the side accelerometers 114, the side pressure sensors 120, and a vehicle data bus 402.

The restraint control module 108 includes a processor or controller 404 and memory 406. In the illustrated example, the restraint control module 108 is structured to include sound monitor 124 and the database of collision signatures 122. The processor or controller 404 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 406 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory 406 includes multiple kinds of memory, particularly volatile memory and non-volatile memory. In the illustrated example, the memory 406 stores the database of collision signatures 122.

The memory 406 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 406, the computer readable medium, and/or within the processor 404 during execution of the instructions.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

The vehicle data bus 402 communicatively couples the GPS receiver 102, the on-board communication module 104, the body control module 106, and the restraint control module 108. In some examples, the vehicle data bus 402 includes one or more data buses. The vehicle data bus 402 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

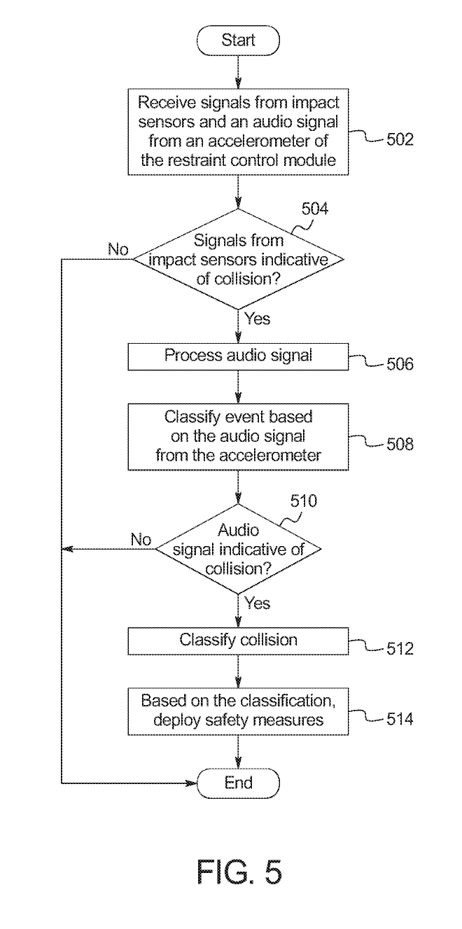

FIG. 5 is a flowchart of a method to distinguish collision and non-collision events, which may be implemented by the electronic components 400 of FIG. 4. Initially, at block 502, the restraint control module 108 receives measurements from the impact sensors (e.g., the front accelerometer 112, the side accelerometers 114, the side pressure sensors 120, etc.) and a signal from the center accelerometer 110 mounted to the metal sheet 116 on the underside 118 of the vehicle 100. At block 504, the restraint control module 108 determines whether the measurements from the impact sensors are indicative of a collision. For example, the restraint control module 108 may compare the measurements from the impact sensors are indicative to vibration thresholds. When the measurements from the impact sensors are indicative of a collision, the method continues at block 506.

At block 506, the restraint control module 108 processes the audio signals from the center accelerometer 110. At block 508, the restraint control module 108 classifies the event as a collision event or a non-collision event based on a comparison of the audio signals to signatures in the database of collision signatures 122. At block 510, the restraint control module 108 determines whether the audio signal is classified as a collision event. When the audio signal is classified as a collision event, the method continues at block 512. At block 512, the restraint control module 108 classifies the collision (e.g., a right side collision, a left side collision, a front collision, etc.). At block 514, the restraint control module 108 deploys safety measures (e.g., one or more of the air bags, etc.) based on the classification of the collision.

The flowchart of FIG. 5 is representative of machine readable instructions stored in memory (such as the memory 406 of FIG. 4) that comprise one or more programs that, when executed by a processor (such as the processor 404 of FIG. 4), cause the vehicle 100 to implement the example sound monitor 124 and, more generally, the example restraint control module 108 of FIGS. 1, 3, and 4. Further, although the example program(s) is/are described with reference to the flowchart illustrated in FIG. 5, many other methods of implementing the example sound monitor 124 and, more generally, the example restraint control module 108 may alternatively be used. For example, the order of execution of the blocks may be changed, and/or some of the blocks described may be changed, eliminated, or combined.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
impact sensors;
a metal panel on an underside of the vehicle;
an accelerometer mounted to the metal panel to measure vibrations of the metal panel caused by sound; and
a restraint control module to:
classify the sound as a collision event or a non-collision event; and
deploy an airbag when the sound is classified as the collision event and the impact sensors indicate the collision event.

2. The vehicle of claim 1, wherein the impact sensors include a second accelerometer that detects the collision event based on vibration of a frame of the vehicle.

3. The vehicle of claim 1, to classify the sound, the restraint control module is to compare the sound to a database containing signatures of a plurality of collision events and a plurality of non-collision events.

4. The vehicle of claim 3, wherein when the sound is classified as the non-collision event, the restraint control module is to cause the sound to play on a sound system of the vehicle.

5. The vehicle of claim 3, wherein when the sound is classified as the non-collision event, the restraint control module is to cause an identifier associated with the sound to play on a sound system of the vehicle.

6. The vehicle of claim 3, wherein the signatures for non-collision events are filtered based on weather data.

7. The vehicle of claim 1, wherein the restraint control module is mounted to the metal panel.

8. The vehicle of claim 1, wherein the restraint control module is to cause the sound to be played on a sound system of the vehicle when the vehicle is in a reverse gear.

9. A method comprising:
measuring vibrations caused by sound of a metal panel on an underside of a vehicle with an accelerometer mounted to the metal panel;
measuring vibrations of a frame of the vehicle with impact sensors;
classifying, with a processor, the vibrations of the metal panel as a collision event or a non-collision event;
classifying, with the processor, the vibrations of the frame as the collision event or the non-collision event; and
deploying an airbag when the sound is classified as the collision event and the vibrations of the frame is classified as the collision event.

10. The method of claim 9, wherein the impact sensors include a second accelerometer that detects the vibrations of the frame of the vehicle.

11. The method of claim 9, wherein classifying the vibrations of the metal panel include comparing the vibrations to a database containing signatures of a plurality of collision events and a plurality of non-collision events.

12. The method of claim 11, including when the vibrations of the metal panel are classified as the non-collision event, playing the vibrations as the sound on a sound system of the vehicle.

13. The method of claim 11, including when the sound is classified as the non-collision event, playing an identifier associated with one of the signatures matching the vibrations of the metal panel on a sound system of the vehicle.

14. The method of claim 11, wherein the signatures for non-collision events are filtered based on weather data.

15. The method of claim 9, including playing the sound on a sound system of the vehicle when the vehicle is in a reverse gear.

16. The method of claim 9, including when the vibrations of the metal panel are classified as the non-collision event, broadcasting a message, via a dedicated short range communication module, to notify to vehicles proximate the vehicle of the non-collision event.
